(19) United States
(12) Patent Application Publication
(10) Pub. No.: US 2005/0229243 A1
(43) Pub. Date: Oct. 13, 2005

(54) Method and system for providing Web browsing through a firewall in a peer to peer network

(76) Inventors: Hugh B. Svendsen, Chapel Hill, NC (US); Al Issa, Apex, NC (US)

Correspondence Address: SAWYER LAW GROUP LLP, P.O. Box 51418, Palo Alto, CA, 94303, US

(21) Appl. No.: 10/813,839

(22) Filed: Mar. 31, 2004

(51) Int. Cl. H04L 9/00; H04L 9/32; G06F 11/30; G06F 12/14

(52) U.S. Cl. 726/12

(57) ABSTRACT

A method and system for providing a computer running a Web browser HTTP access to a peer server located behind a firewall in a peer-to-peer network is described. The method and system first include providing the peer-to-peer network with a proxy server. The peer server then registers an outbound socket connection with the proxy server. In response to the proxy server receiving an HTTP request to access the peer server from the web browser, the HTTP request is translated into a request packet and the request packet is sent to the peer server. In response to the peer server receiving the request packet, the peer server translates the request packet back into the HTTP request and then responds to the request, thereby enabling generic web traffic to flow.

### FIELD OF THE INVENTION

The present invention relates to peer-to-peer online photosharing, and more particularly to a method and system for providing Web browsing through a firewall within the peer-to-peer network.

### BACKGROUND OF THE INVENTION

The most popular approach from online photosharing is a serving architecture based on centralized computing, where a central server provides photosharing services to users by serving images to their web browsers from a fixed location on the Internet. FIG. 1 is a diagram illustrating a conventional server architecture 10 that includes a client 12 connecting to a Web server 14 through a web browser 16. Communications between the Web browser 16 and the Web server 14 is based on hypertext transport protocol (HTTP). The function of HTTP is to establish a connection between the Web browser 16 and the Web server 14 and to transmit HTML pages from the Web server 14 to the client browser 16 or any other files required by an HTTP application.

HTTP is a request/response system. The connection is maintained between client 12 and server 14 only for the immediate request. Using Transmission Control Protocol/Internet Protocol (TCP/IP), the Web browser 16 first establishes a TCP connection with the server 14, and then sends an HTTP request command 18 to the Web server 14. The Web server 14 responds by sending back TCP/IP packets 20 in the form of headers (messages) and files (HTML pages, Java applets, etc.), and then closes the connection. As is well-known, TCP/IP is a routable protocol where all messages contain not only the address of the destination station, but the address of a destination network. Every client 12 and server 14 in a TCP/IP network requires an IP address, which is either permanently assigned or dynamically assigned at startup.

Although this solution works reasonably well for many photosharing situations, the disadvantage is that this solution fails if the Web server 14 is located behind a firewall. A similar problem exists with new peer-to-peer (P2P) photosharing applications in which each computer/peer in the P2P network acts as a server to share pictures with others in the network without the users having to upload their pictures to a Web site. One example of such a P2P application is Photo Vibe 1.2 by XFormx, Inc. of Needham, Mass. The difficulty, however, is that not all computers have fixed IP addresses (due to a global shortage), and the peers often reside behind firewalls due to the hostile nature of the Internet towards unprotected systems. The challenge therefore resides in how to access these computers using standard HTTP when the computers are using dynamic IP, and reside behind firewalls either at home or on corporate LANs.

One solution is to assign a fixed address to all computers in the peer-to-peer topology, and then cause any peers behind firewalls to open a port in the firewall to allow incoming Internet traffic. This solution works well from a technical standpoint, but requires extra steps in network configuration, and opens a potential security flaw in a user's network. This solution is used by multiple Internet games as well as peer-to-peer photosharing software solutions, such as Photo Vibe 1.2. Although this configuration supports a general HTTP/Web browser environment, the disadvantage of this solution is that it requires users to punch a hole in their firewall, and to assign static IP addresses to the peer computers or use a dynamic DNS services ( such as www.no-ip.com) to track the changing address.

Accordingly, what is needed is a method system for providing HTTP access to each peer in the photosharing P2P network from other computers, even when some of the peers are located behind firewalls. The present invention addresses such a need.

### SUMMARY OF THE INVENTION

The present invention provides a method and system for providing a computer running a Web browser HTTP access to a peer server located behind a firewall in a peer-to-peer network. The method and system first include providing the peer-to-peer network with a proxy server. The peer server then registers an outbound socket connection with the proxy server. In response to the proxy server receiving an HTTP request to access the peer server from the web browser, the HTTP request is translated into a request packet and the request packet is sent to the peer server. In response to the peer server receiving the request packet, the peer server translates the request packet back into the HTTP request and then responds to the request, thereby enabling generic web traffic to flow.

According to the method and system disclosed herein, the present invention supports generic web browsing between a visitor and a peer running behind a firewall without requiring any network configuration, and without requiring that a port be opened in the firewall for incoming connections.

### BRIEF DESCRIPTION OF THE DRAWINGS

FIG. 1 is a diagram illustrating a conventional server architecture.

FIG. 2 is a diagram illustrating the hybrid peer-to-peer architecture of the present invention.

FIG. 3 is a flow diagram illustrating the process for enabling a web browser access to a peer server behind a firewall.

FIG. 4 is a flow diagram illustrating the process of a peer server registering with the photosharing peer-to-peer network to make its serving capabilities assessable through a firewall.

FIG. 5 is a diagram illustrating components of the proxy server and the flow between the requesting web browser, the proxy server, and the peer server to enable the web browser to have HTTP access to the peer server through the proxy server.

FIG. 6A is a diagram illustrating the contents of a peer request packet.

FIG. 6B is a diagram illustrating the contents of a peer response packet.

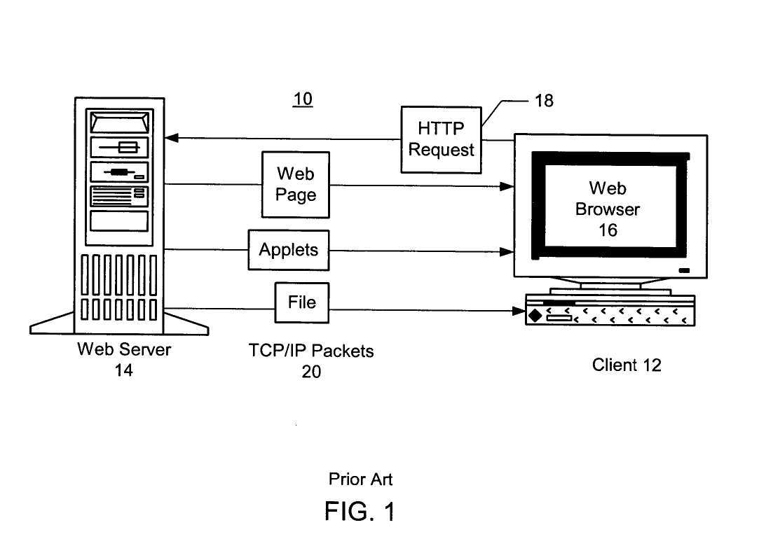

### DETAILED DESCRIPTION OF THE INVENTION

The present invention relates to a method for providing secure Web browsing in a peer-to-peer network. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a hybrid peer-to-peer architecture for general HTTP/web browser configuration that incorporates a central proxy server to coordinate networking traffic for peers behind firewalls, thus allowing access to peers behind firewalls by other peers and by visiting computers not in the network.

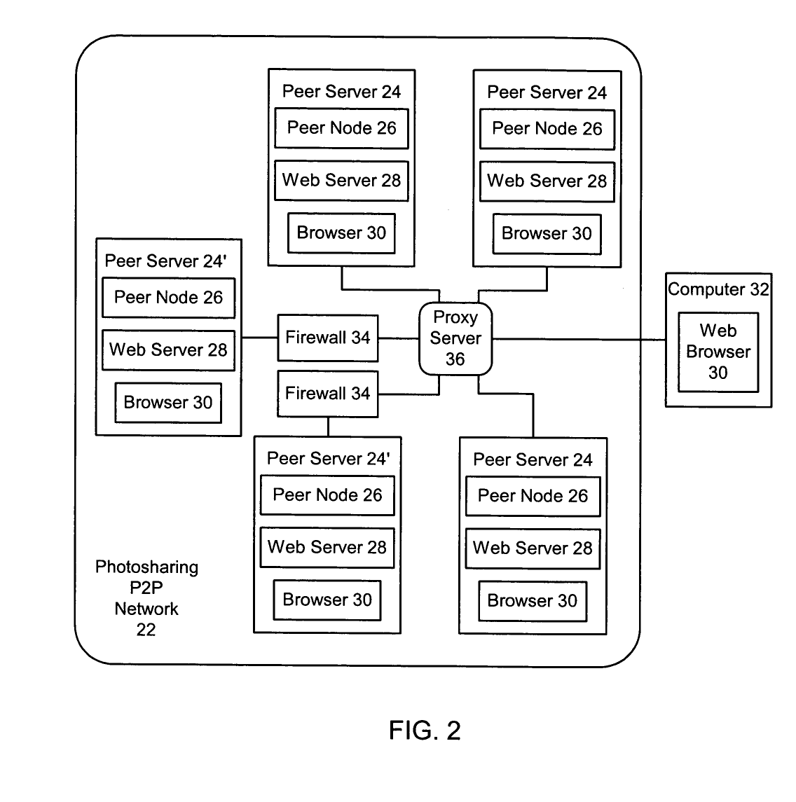

FIG. 2 is a diagram illustrating the hybrid peer-to-peer architecture of the present invention. The hybrid peer-to-peer architecture 20 includes a photosharing P2P network 22, which comprises multiple peer servers 24 running peer node software 26 and Web server software 28. In a preferred embodiment of the present invention, the peer node and server software 24 and 26 enable the users of the computers to share pictures with others in the network through a Web browser 30 without having to upload their pictures to a Web site. A visiting computer 32, i.e., one not belonging to the peer-to-peer network 22, also accesses images from the peer servers 24 via a Web browser 30. As used herein, the peer servers 24 and the visiting computer 32 may comprise any computing device with components necessary for executing the appropriate software, such as PCs, workstations, cellphones, and PDAs, for instance. Also, in a preferred embodiment, the physical communications network is the Internet, although any type network could be used.

As shown, some of the peer servers 24′ within the P2P network 22 are located behind firewalls 34, which block conventional HTTP requests from the other peer servers 24 and visiting computer 32. According to the present invention, the hybrid peer-to-peer architecture 20 enables the web browser 30 running on another computer, either visiting computer 32 or another peer server 24, with HTTP access to the peer server 24′. As used herein, HTTP access refers to the following activities: browsing web pages, file downloads and conducting transactions.

Generic HTTP access is accomplished by providing the P2P network 22 with at least one proxy server 36 that is separate and apart from the peer servers 24 comprising the network 22, and allowing a user of a firewall-protected peer server 24′ with the enable incoming web traffic by establishing an outbound connection from the firewall-protected peer server 24′ with the proxy server 36. Incoming Web traffic for the firewall-protected peer server 24′ is then directed to the proxy server 36. The proxy server 36 multiplexes the Web traffic using a proprietary protocol to the peer server 24′, thus enabling generic web traffic to flow to the peer server 24′ despite the presence of the firewall 34. In the case where there are multiple firewall-protected peer servers 24′, the proxy server 36 acts as a switchboard to receive and dispatch the incoming HTTP requests to the appropriate peer servers 24′.

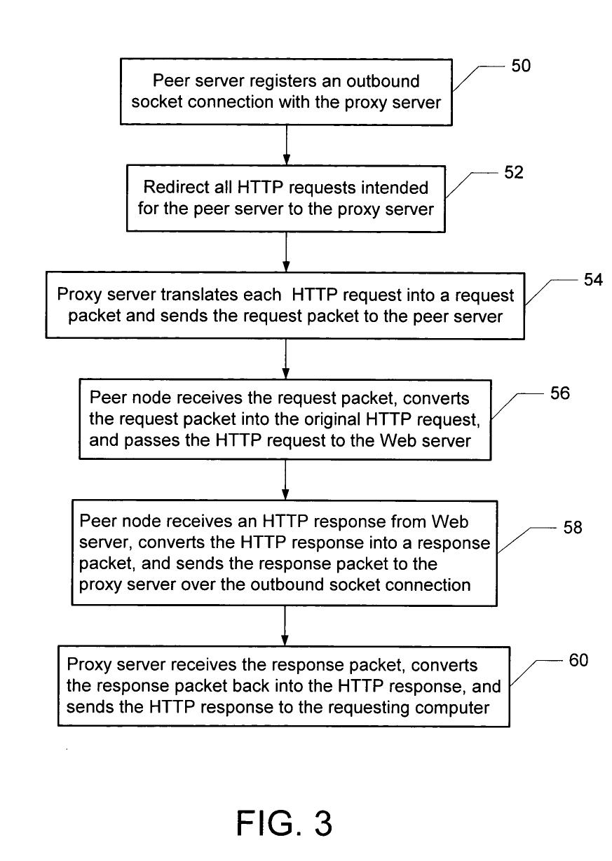

FIG. 3 is a flow diagram illustrating the process for enabling a Web browser 30 to access the peer server 24′ behind a firewall 34. The process begins in step 50 with the peer server 24 registering an outbound socket connection with the proxy server 36. In step 52, all incoming HTTP requests intended for the peer server 24′ are redirected to the proxy server 36. In response to receiving a redirected HTTP request in step 54, the proxy server 36 finds the socket connection to the peer server 24′, translates the HTTP requests into a multiplexed protocol comprising a request packet, and sends the request packet to the peer server 24′. In step 56, the peer node 26 receives the request packet, demultiplexes the request, converts the request packet back into the original HTTP request, and passes the HTTP request to the local Web server 28. In step 58, the peer node 26 receives an HTTP response from Web server 28, converts the HTTP response into a response packet, and sends the response packet to the proxy server 36 over the outbound socket connection. In step 60, the proxy server 36 receives the response packet from the peer server 24′, converts the response packet back into the HTTP response, and sends the HTTP response to the requesting web browser 30.

The present invention is an improved solution over prior techniques in that it supports generic web browsing between a visitor and a peer running behind a firewall without requiring any network configuration. This is different from an ordinary HTTP proxy (which is well known to those with ordinary skill in the art) in that the direction between the proxy and the serving machine has been reversed. This complicates the situation because the HTTP protocol mandates that the end of an HTTP request be signaled by closing the socket connection by the serving entity. In the present invention, that connection is kept open, because it is that connection that makes the peer server 24′ addressable. This problem has been solved by always keeping the connection from the peer to the central proxy server 36 open. The poxy server 36 uses this open connection as a control socket. It receives HTTP request from a visiting browser 30, turns those request into commands, and sends them to the peer server 24′ doing the web serving. The peer server 24′ doing the web serving runs daemon, which receives the commands, and feeds them to its local web server 28. It then takes the HTTP responses and sends them to the peer server 24′ by opening an out bound connection, sending the data, then sends an end-of-packet message to signify completion of the peer response packet.

Furthermore, the present invention negates the need for the peer server 24′ to have a known IP address. Because the peer server 24′ connects to the proxy server 36, the proxy server 36 does not need to know the address of the peer server 24′ for the system 20 to operate. This is an advantage in mobile settings because the peer server 24′ may move from one network to another. This is important in the consumer setting because a typical internet service provider ISP will dynamically change an IP address through the use of DHCP.

Another advantage of the present invention is that it allows users in corporate settings to use the system. This is facilitated because a port does not have to be opened in the firewall for incoming connections. This is important for corporate users because the security standards in those environments are much higher. They would rarely, if ever, consider punching a hole in their firewall.

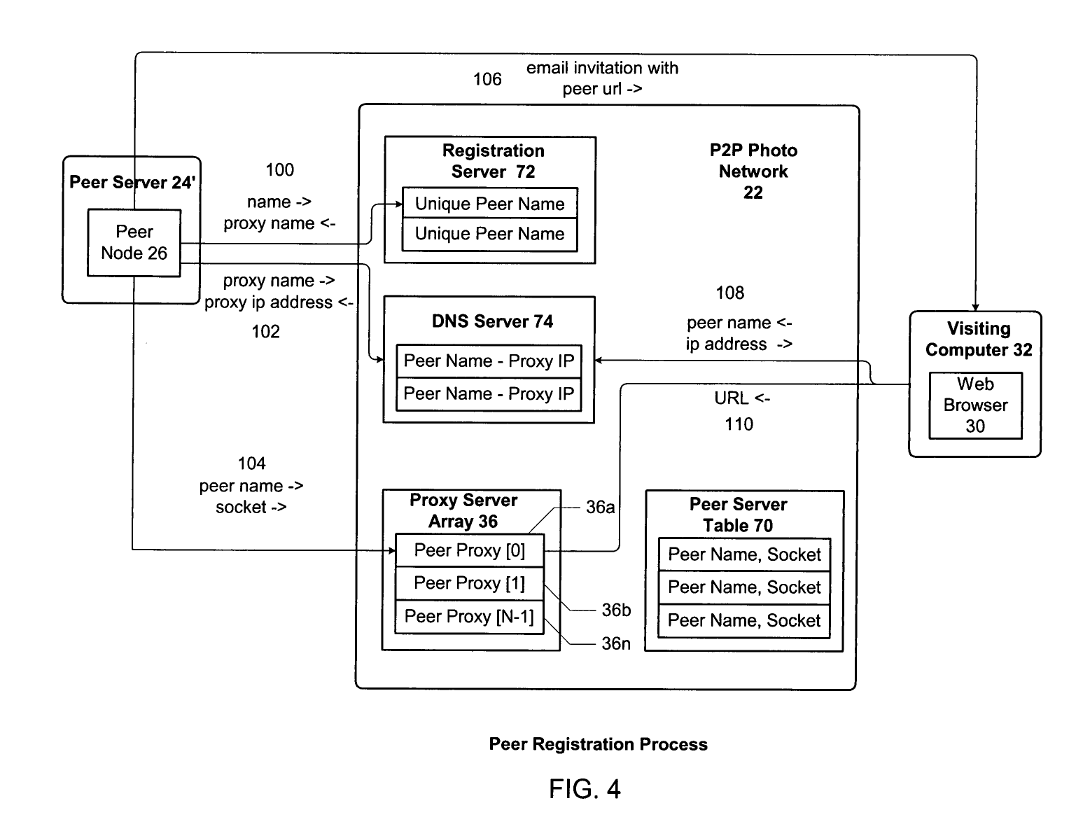

FIG. 4 is a flow diagram illustrating the process of a peer server 24′ registering with the photosharing peer-to-peer network 22 to make its serving capabilities assessable through a firewall 34. In a preferred embodiment, the P2P network 22 includes several proxy servers 36a-n, referred to collectively as proxy server array 36, a peer server table 70, a registration server 72, and a DNS server 74.

The registration process begins in step 100, in which the peer node 26 passes its name to the registration server 72, the registration server 72 checks to make sure that the peer name is unique, and returns to the peer node 26 the name and IP address of the proxy server 36 to which it is assigned. In step 102, the peer node 26 registers its proxy server name and proxy server IP address with the DNS server 74. The DNS server 74 maintains a table of all peer names and their corresponding proxy IP addresses. In step 104, the peer node 26 registers the peer server's name and socket to proxy server 36 to which it was assigned.

In step 106, a user of the visiting computer 32 is notified that content (e.g., photos) exists on the peer server 24′ for viewing. The notification could be implemented using several methods, but in a preferred embodiment, the user is notified via e-mail, with the e-mail including the URL of the content in the peer server 24′. In step 108, the user of the visiting computer 32 receives the e-mail, and clicks on the URL. Using the peer name in the URL, the visiting computer 32 contacts the DNS server 74 to determine the identity of the proxy server 36 in which to send the request. The DNS server 74 responds with the IP address of the proxy server 36 assigned to the peer server 24′. Given the proxy IP address, the web browser 30 of the visiting computer 32 sends an HTTP request to the proxy server 36 in step 110.

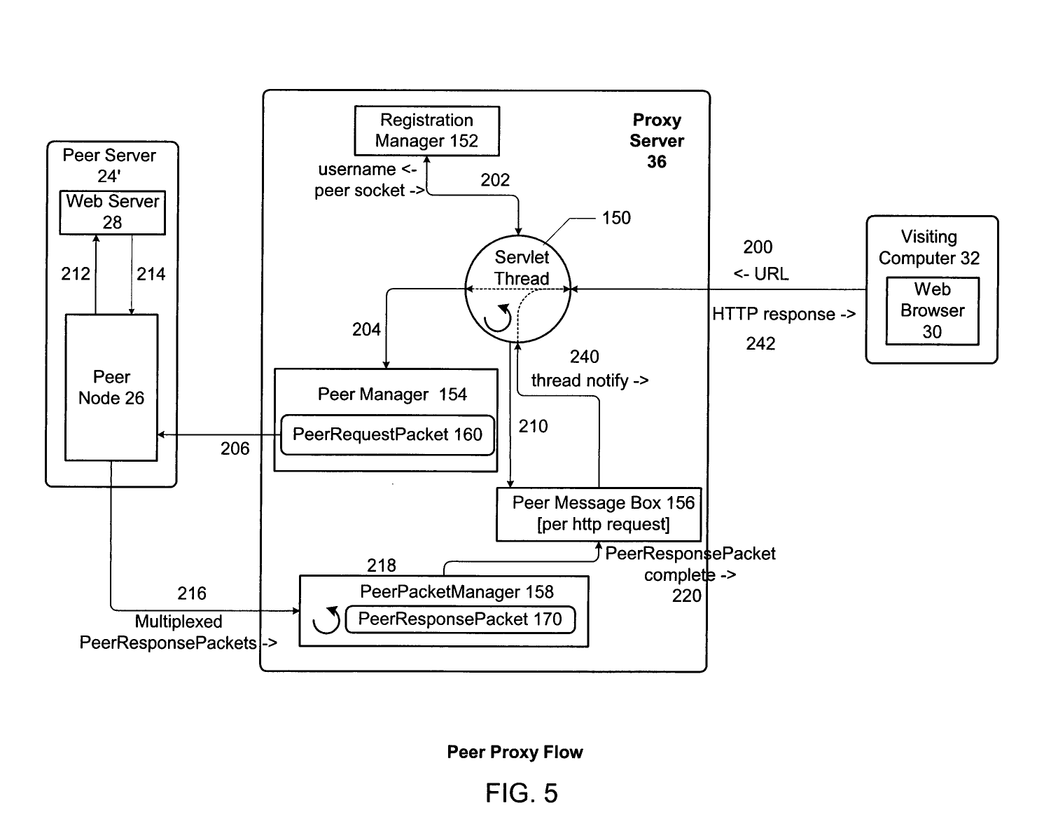

FIG. 5 is a diagram illustrating components of the proxy server 36 and the flow between the requesting web browser 30, the proxy server 36, and the peer server 24′ to enable the web browser 30 to have HTTP access to the peer server 24′ through the proxy server 36. In a preferred embodiment, the proxy server 36 includes multipleservlet threads 150, a registration manager 152, a peer manager 154, a peer MessageBox 156, and a peer packet manager thread 158.

The process begins in step 200 when the servlet thread 150 in the proxy server 36 receives the HTTP request in the form of a URL from the web browser 30. In step 202, the registration manager 152 checks the server table 70 (see FIG. 4) to determine if the peer server identified in the requesting URL is registered with the peer server 24′, and if so, returns the corresponding peer socket. In step 204, the servlet thread 150 creates a peer request packet 160 from the HTTP request and then passes that packet to the peer manager 154.

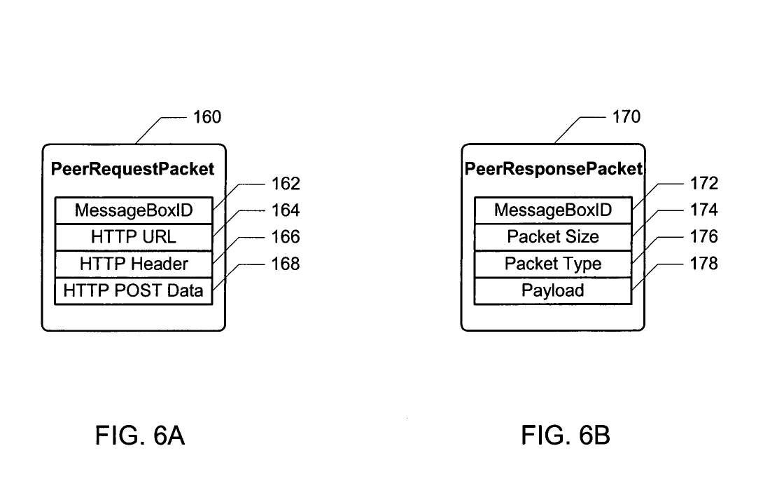

FIG. 6A is a diagram illustrating the contents of a peer request packet 160. In a preferred embodiment, the peer request packet 160 includes a MessageBoxID 162, an HTTP URL 164, multiple HTTP headers 166, and an HTTP Post Data field 168. The MessageBoxID 162 is a unique identifier for correlating peer request packets 162, peer response packets 170, and peer message boxes 156. The HTTP URL 164 is the URL that was requested from the visiting web browser 30. The HTTP Headers 166 is the HTTP headers from the original request from the visiting web browser 30. The HTTP Post Data field 168 contains data for when the request is a POST command, and not a GET command.

Referring again to FIG. 5, in step 206, the peer manager 154 finds the socket connection to the peer server 24′ and passes the peer request packet 160 to peer server 24′. In step 210, the servlet thread 150 gets a peer MessageBox 156 from the peer manager 154 and blocks, waiting for response packets to arrive in the peer MessageBox 156.

In step 212, the peer node 26 receives the request packet 160, converts the packet 160 back into an HTTP request, and sends the HTTP request to the web server 28. In step 214, an HTTP response is sent from the web server 28 to peer node 26, which then takes the HTTP headers from the response, creates a peer response packet 170, and sends it back to the proxy server 36. The remaining portion of the HTTP response is broken up into 2K chunks in step 216 and sent to the proxy server 36 in successive peer response packets 170. In a preferred embodiment, the peer node 26 inserts a routing address with each peer response packet 170. Note that there can be several threads handling request from the proxy server 36. Therefore, the peer node 26 multiplexes those responses over the same response socket back to the proxy server 36.

FIG. 6B is a diagram illustrating the contents of a peer response packet 170. In a preferred embodiment, the peer response packet 170 includes a MessageBoxID 172, a packet size 174, a packet type 176, and a payload field 178. The MessageBoxID 172 is a unique identifyer for correlating peer request packets 162, peer response packets 170, and peer message boxes 156. The packet size 174 has to do with the fact that the response to the peer request packet 160 is sent back to the proxy server 36 in chunks. A packet size of 2K is used in the preferred embodiment. The individual packets are reassembled on the proxy server 36 to form the complete HTTP response, which is then returned to the visiting web browser 30. The packet type 176 indicates the type of data being returned in the payload field 178. Possible values include: [data, header, final packet]. The payload field 178 is the data portion of the peer response packet 170.

Referring again to FIG. 5, in step 218, the proxy server 36 receives raw bytes over the response socket and passes them to a peer packet manager 158 thread selected from a thread pool. In a preferred embodiment, there is only one peer packet manager thread per peer that is actively receiving requests 158 in the proxy server 36 170. In step 220, the peer packet manager thread 158 waits until there is a complete packet in its buffer, then routes the complete peer response packet 170 to the corresponding peer MessageBox 156. When the packet 170 arrives in the peer MessageBox 156, the corresponding servlet thread 150 wakes up and retrieves the complete peer response packet 170. In step 242, the servlet thread 150 converts the peer response packet 170 back into an HTTP response and then sends the HTTP response back to the requesting web browser 30. As disclosed herein, a combination of the proxy server 36 and the peer node 26 enable HTTP access to a peer server 24′ located behind a firewall 34 by a visiting web browser 30.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

1. A method for providing a Web browser running on a computer with HTTP access to a peer server located behind a firewall in a peer-to-peer network, comprising;
(a) providing the peer-to-peer network with a proxy server;
(b) registering an outbound socket connection with the proxy server by the peer server;
(c) in response to the proxy server receiving an HTTP request to access the peer server from the Web browser, translating the HTTP request into a request packet and sending the request packet to the peer server; and
(d) in response to the peer server receiving the request packet, translating the request packet back into the HTTP request and responding to the request, thereby enabling generic web traffic to flow.

2. The method of claim 1 wherein the peer server further includes a Web server, step (d) further including the steps of:
(i) responding to request by passing the HTTP request to the Web server;
(ii) receiving an HTTP response from Web server;
(iii) translating HTTP response into a response packet;
(iv) sending the response packet to peer server to the proxy server over the outbound socket connection;
(v) receiving the response packet on the proxy server and translating a response packet back into the HTTP response; and
(vi) sending the HTTP response from the peer server to the Web browser.

3. The method of claim 2 wherein the peer-to-peer network includes multiple peer servers, and the proxy server is separate and apart from the peer servers.

4. The method of claim 3 further including the step of: providing each of the peer servers with a peer node, a Web server, and a Web browser.

5. The method of claim 4 further including step of: providing the peer-to-peer network with a registration server and a DNS server.

6. The method of claim 5 wherein step (b) further includes the step of: passing a name of the peer server from the peer server to the registration server, and receiving a name and IP address of the proxy server to which it is assigned.

7. The method of claim 6 wherein step (b) further includes the step of: registering by the peer server, the name of the proxy server, and the IP address of the proxy server with the DNS server.

8. The method of claim 7 wherein step (b) further includes the step of: after the peer server registers with the proxy server, notifying a user of the computer via e-mail that content exists on the peer server for viewing, and including a URL of the peer server in the e-mail.

9. The method of claim 8 wherein step (b) further includes the step of: in response to the user clicking on the URL e-mail, the computer contacts the DNS server to determine an identity of the proxy server in which to send the HTTP request.

10. A method of claim 3 further including the step of: providing the proxy server with a servlet thread, a registration manager, a peer manager, a peer MessageBox, and a peer packet manager thread.

11. The method of claim 10 wherein step (c) further includes the step of: receiving the HTTP request as a URL by the servlet thread and using the registration manager to determine if the peer server identified in requesting URL is registered with the peer server, and if so, returning the corresponding peer socket.

12. The method of claim 11 wherein step (c) further includes the step of: creating, by the servlet thread, a peer request packet, and passing the peer request packet to the peer manager.

13. The method of claim 12 wherein step (c) further includes the step of: providing the peer request packet with a MessageBoxID, an HTTP URL, HTTP headers, and an HTTP Post Data field.

14. The method of claim 13 wherein step (c) further includes the step of: finding by the peer manager, the socket connection to the peer server, and passing the peer request packet to the peer server.

15. The method of claim 2 wherein step (d) further includes the step of: breaking the HTTP response into chunks and sending the chunks to the proxy server in successive peer response packets.

16. The method of claim 15 wherein step (d) further includes the step of: providing the peer server with several threads for handling HTTP requests from the proxy server, and multiplexing responses to those requests over the same response socket back to the proxy server.

17. A computer-readable medium containing program instructions for providing a Web browser running on a computer with HTTP access to a peer server located behind a firewall in a peer-to-peer network, the program instructions for;
(a) providing the peer-to-peer network with a proxy server;
(b) registering an outbound socket connection with the proxy server by the peer server;
(c) in response to the proxy server receiving an HTTP request to access the peer server from the Web browser, translating the HTTP request into a request packet, and sending the request packet to the peer server; and
(d) in response to the peer server receiving the request packet, translating the request packet back into the HTTP request and responding to the request, thereby enabling generic web traffic to flow.

18. The computer-readable medium of claim 17 wherein the peer server further includes a Web server, instruction (d) further including the instructions of:
(i) responding to request by passing the HTTP request to the Web server;
(ii) receiving an HTTP response from Web server;
(iii) translating HTTP response into a response packet;
(iv) sending the response packet to peer server to the proxy server over the outbound socket connection;
(v) receiving the response packet on the proxy server and translating a response packet back into the HTTP response; and
(vi) sending the HTTP response from the peer server to the Web browser.

19. The computer-readable medium of claim 18 wherein the peer-to-peer network includes multiple peer servers, and the proxy server is separate and apart from the peer servers.

20. The computer-readable medium of claim 19 further including the instruction of: providing each of the peer servers with a peer node, a Web server, and a Web browser.

21. The computer-readable medium of claim 20 further including instruction of: providing the peer-to-peer network with a registration server and a DNS server.

22. The computer-readable medium of claim 21 wherein instruction (b) further includes the instruction of: passing a name of the peer server from the peer server to the registration server, and receiving a name and IP address of the proxy server to which it is assigned.

23. The computer-readable medium of claim 22 wherein instruction (b) further includes the instruction of: registering by the peer server, the name of the proxy server and the IP address of the proxy server with the DNS server.

24. The computer-readable medium of claim 23 wherein instruction (b) further includes the instruction of: after the peer server registers with the proxy server, notifying a user of the computer via e-mail that content exists on the peer server for viewing, and including a URL of the peer server in the e-mail.

25. The computer-readable medium of claim 24 wherein instruction (b) further includes the instruction of: in response to the user clicking on the URL e-mail, the computer contacts the DNS server to determine an identity of the proxy server in which to send the HTTP request.

26. A computer-readable medium of claim 19 further including instruction of: providing the proxy server with a servlet thread, a registration manager, a peer manager, a peer MessageBox, and a peer packet manager thread.

27. The computer-readable medium of claim 26 wherein instruction (c) further includes the instruction of: receiving the HTTP request as a URL by the servlet thread and using the registration manager to determine if the peer server identified in requesting URL is registered with the peer server, and if so, returning the corresponding peer socket.

28. The computer-readable medium of claim 27 wherein instruction (c) further includes the instruction of: creating, by the servlet thread, a peer request packet, and passing the peer request packet to the peer manager.

29. The computer-readable medium of claim 28 wherein instruction (c) further includes the instruction of: providing the peer request packet with a MessageBoxID, an HTTP URL, an HTTP headers, and an HTTP Post Data field.

30. The computer-readable medium of claim 29 wherein instruction (c) further includes the instruction of: finding by the peer manager, the socket connection to the peer server, and passing the peer request packet to the peer server.

31. The computer-readable medium of claim 18 wherein instruction (d) further includes the instruction of: breaking the HTTP response into chunks and sending the chunks to the proxy server in successive peer response packets.

32. The computer-readable medium of claim 31 wherein instruction (d) further includes the instruction of: providing the peer server with several threads for handling HTTP requests from the proxy server, and multiplexing responses to those requests over the same response socket back to the proxy server.

33. A method for providing a web browser with HTTP access to a peer server located behind a firewall in a peer-to-peer network, comprising:
(a) registering an outbound socket connection from the peer server to a proxy server;
(b) redirecting all incoming HTTP requests intended for the peer server to the proxy server;
(c) in response to the proxy server receiving one of the redirected HTTP request, finding the socket connection to the peer server, translating the HTTP requests into a multiplexed protocol comprising a request packet, and sending the request packet to the peer server;
(d) in response to the peer node receiving the request packet, demultiplexing the request, translating the request packet back into the original HTTP request, and passing the HTTP request to a local web server;
(e) in response to the peer node receiving an HTTP response from the Web server, translating the HTTP response into a response packet, and sending the response packet to the proxy server over the outbound socket connection; and
(f) in response to the proxy server receiving the response packet from the peer server, translating the response packet back into the HTTP response, and sending the HTTP response to the requesting Web browser.

34. A computer-readable medium containing program instructions for providing a web browser with HTTP access to a peer server located behind a firewall in a peer-to-peer network, the program instructions for:
(a) registering an outbound socket connection from the peer server to a proxy server;
(b) redirecting all incoming HTTP requests intended for the peer server to the proxy server;
(c) in response to the proxy server receiving one of the redirected HTTP request, finding the socket connection to the peer server, translating the HTTP requests into a multiplexed protocol comprising a request packet, and sending the request packet to the peer server;
(d) in response to the peer node receiving the request packet, demultiplexing the request, translating the request packet back into the original HTTP request, and passing the HTTP request to a local web server;
(e) in response to the peer node receiving an HTTP response from the Web server, translating the HTTP response into a response packet, and sending the response packet to the proxy server over the outbound socket connection; and
(f) in response to the proxy server receiving the response packet from the peer server, translating the response packet back into the HTTP response, and sending the HTTP response to the requesting Web browser.
